(19) United States
(12) Patent Application Publication
(10) Pub. No.: US 2017/0300934 A1
(43) Pub. Date: Oct. 19, 2017

(54) INFORMATION/MARKETING/REVENUE SYSTEM AND METHOD

(71) Applicant: DAVID NICHOLS, Armonk, NY (US)

(72) Inventor: DAVID NICHOLS, Armonk, NY (US)

(21) Appl. No.: 15/132,191

(22) Filed: Apr. 18, 2016

(51) Int. Cl. G06Q 30/02; G06T 19/00

(52) U.S. Cl. CPC G06Q 30/0201; G06Q 30/0277; G06T 19/006

(57) ABSTRACT

AR (comprising Augmented Reality, Mixed Reality, Virtual reality and the use of visual recognition are new technologies that have yet to gain widespread acceptance let alone any type of consumer commercialization. The invention addresses many of the issues hindering its growth including boring content, static content, lack of sampling technology, no way to appropriately give as a gift or to collect and lack of information regarding the availability of various apps, cost, length of time for use, unattractive method of obtaining the AR functionality, non-functional method of selling AR to consumers as well as other factors. The invention provides a complete system and method to introduce and enhance the value of AR

### CROSS-REFERENCE TO RELATED APPLICATIONS

This application claims the benefit of U.S. Provisional Patent Application Ser. No. 62/149,149, entitled “Information/Marketing/Revenue System and Method,” the entire disclosure of which is hereby incorporated by reference.

### BACKGROUND OF THE INVENTION

Augmented Reality and the use of visual recognition are new technologies that have yet to gain widespread acceptance let alone any type of consumer commercialization.

During an initial rollout period these technologies were offer for free for experimentation purposes. After that only companies that could justify the cost or had budgets large enough to afford to experiment continued in the area. The overwhelming focus for AR companies and potential customers has been the print industry, specifically newspapers and magazines.

The use of AR has been limited due to several factors many of which are addressed and resolved with the invention. When AR is used in print it is accompanied by a page explaining AR and explaining a symbol used in the periodical to denote AR within an ad. Different magazines and different newspapers use different symbols to denote that there is AR content. Not only is this cumbersome and wasteful but it takes space away from the ad itself and changes the aesthetics of the ad. This is especially important when the image is an important part of the item or is a logo which would be altered by the addition of an outside symbol. For AR to move beyond magazine print it would be important for there to be a way to identify it as an AR item without disturbing the underlying aesthetics.

If you are asking consumers to purchase a product with AR as a component they would naturally want to know how long the AR component will be made available to them. There might even be an assumption that AR will last for the life of the product. This is an incorrect assumption since providing AR comes with a cost and it is unrealistic to believe that companies will continue to bear the ongoing cost of providing AR indefinitely with no ongoing return against that cost. Therefore, there must be a way for consumers to find out how long the AR component of their item will continue to work.

Having the same result appear from a trigger can become boring and greatly minimizes any perceived value and interest. Therefore, in order to create interest and value in an AR item you would ideally provide rich content which changes on some type of periodic basis. There is a real problem with trying to create and offer interesting, informative and entertaining content since there is presently no way to generate revenue on an ongoing basis to cover the related costs. Likewise, there is a continuing cost of just providing the content through AR and that cost has no current way of being covered.

It is extremely hard for AR items to generate interest and to get potential customers to purchase them if there was no way for the potential customer to see in advance what this new technology is all about let alone, an idea of the specific result for that particular AR item. Just as important is the fact that the potential customer has no way to know if the technology for that particular item that he might purchase would work with his currently owned device.

It would be very advantageous for several reasons including economies of scale to be able to have an AR item that could be useful and therefore enticing for purchase from a worldwide population. Unfortunately, people speak different languages and to many people content provided in a “foreign” language is not of any use to them. One possible solution would be to have different images on the AR products of different languages. One design would trigger content in a language such as English; another similar AR item would have a different design which would trigger the same content but with a different language like Spanish and on and on. This creates higher costs, inventory and storage issues. It would be more advantageous to use the one image for a particular AR item worldwide and have the ability for the user to have an app which provides his chosen language for the content provided and for him to be able to see that that app is available and to obtain that app.

If people were to purchase an app that provides AR for a particular AR item it would be advantageous for them to be able to have a place where they can see, locate and/or purchase other AR items that would also work with that particular item. This is especially true if they are getting an app for a specific language or for a specific category or brand.

If people wanted to be registered in a system regarding AR, it would be desirable for them to have the easiest way to register for the first time or to update the system for additional items they have acquired. One such system might let them read a design with a device and have it automatically added to their account as an AR item and/or an App.

Potential customers considering purchasing an AR item might want the easiest way to see what apps work with that item or what other AR items work with the same apps. One such system might let them read a design with a device and have it show how long the current app will function, what apps are available, the cost of new apps, etc.

Marketers and content owners are interested in selling items and apps that have an AR component. If someone purchased an item with AR it would be beneficial to them to have ways to cross market other items or apps to that same purchaser. As an example assume someone buys a Disney item with designs and AR related to the Disney movie Frozen. The app that powers the AR might work with 50 or 100 additional items such as a Beauty and the Beast item. Both Disney and the potential purchaser would be happy if the purchaser was able to easily see other items that worked with the app for the “Frozen” item. It might encourage him to buy the app if he hadn't yet and might encourage him to buy the other Disney items that work with that app. To make it even easier he would either be directed to where he could purchase the items or buy them directly from the site.

It is possible that the following for a particular AR item might shrink to a small enough level where it no longer justifies having an app. One possible solution is to “pool” similar items together in one app and then share the revenue for that app. To do this it would be necessary to have a way for a consumer to learn what app he could use for his item. As an example assume there is an item and corresponding app for scenes from the show SEINFELD. In the future the demand for that item might shrink to where it does not justify the costs of its own app. That item might be moved to work with similar content item under another app such as TV COMEDY CLASSICS. In this regard you would have to have a way for a user to know that his item will now be working with the new app and what additional items will work with the new app.

It is thus desirable to have an information/marketing/revenue system which would instantly denote to a user that an item is an AR item while at the same time not disturbing the aesthetics of a design or logo

It is thus desirable to have an information/marketing/revenue system which would allow a current or potential owner of an AR item, a way to look up how long the AR on their item will last.

It is thus desirable to have an information/marketing/revenue system which would generate revenue to content providers on an ongoing basis allowing them to provide interesting, informative and entertaining content through AR on an ongoing basis.

It is thus desirable to have an information/marketing/revenue system that would enable potential customers to tryout a product in a store or other location to see one or more samples of the results of the technology without giving them full access to the content, in order to entice them to purchase and to show them that their device will function properly with the product.

It is thus desirable to have an information/marketing/revenue system would allow you to offer one AR item for people that speak different languages and have a method for them to see what languages are available for the item they are interested in and to obtain the corresponding app for their language for that AR item.

It is thus desirable to have an information/marketing/revenue system that would allow you to look up an AR item you may own or consider obtaining and see the corresponding Apps available for that item and by looking up the App see what other AR items work with that app, where the items can be obtained or directly purchase those items.

It is thus desirable to have a system which would have a database filled with AR item designs and related information such that a user could “read” a design of an item he has acquired and the system would automatically update his record.

It is thus desirable to have an information/marketing/revenue system that would let you “read” a design on an AR item and automatically show the user what apps are available with that design along with other information

It is thus desirable to have a way for purchasers of an AR item or app to be able to see what other items work with that app and to purchase those items or to see what other apps work with the AR item

It is thus desirable to have an information/marketing/revenue system would allow you to look up an AR item you may own or consider obtaining and see the corresponding Apps available and by looking up the App see what other AR items work with that app, where the items can be obtained or directly purchase those items.

### SUMMARY OF THE INVENTION

### Brief Description of the Drawings

FIG. 1 is an illustration of one type of AR product optimized for AR, in accordance with an embodiment of the present invention;

FIG. 2 is a schematic diagram of an exemplary information/marketing/revenue system in accordance with an embodiment of the present invention;

FIG. 3 is a flowchart of an exemplary embodiment of the method of the present invention

### DETAILED DESCRIPTION

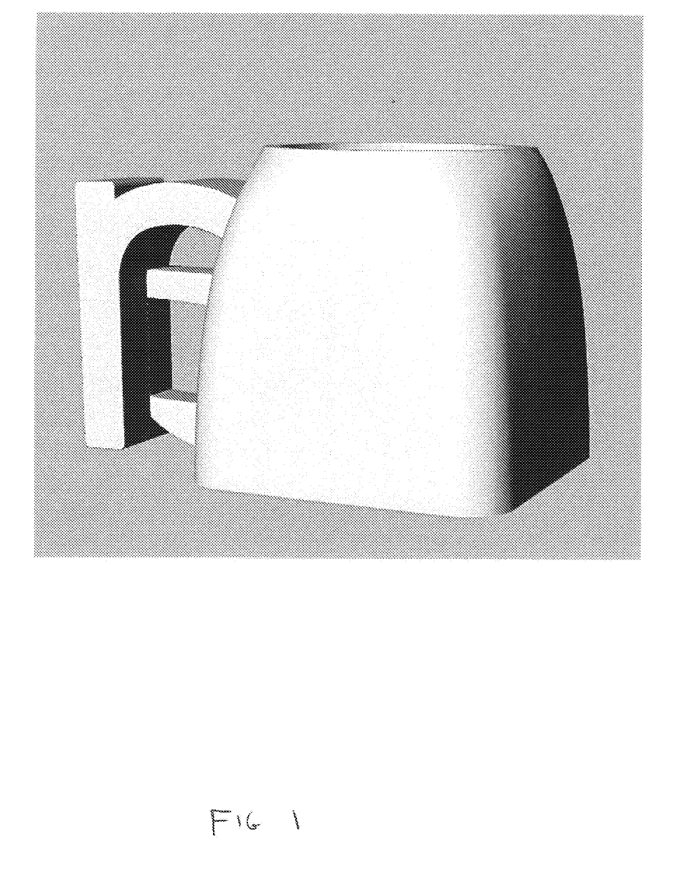

FIG. 1 depicts an exemplary example of an AR product in accordance with an embodiment of the present invention

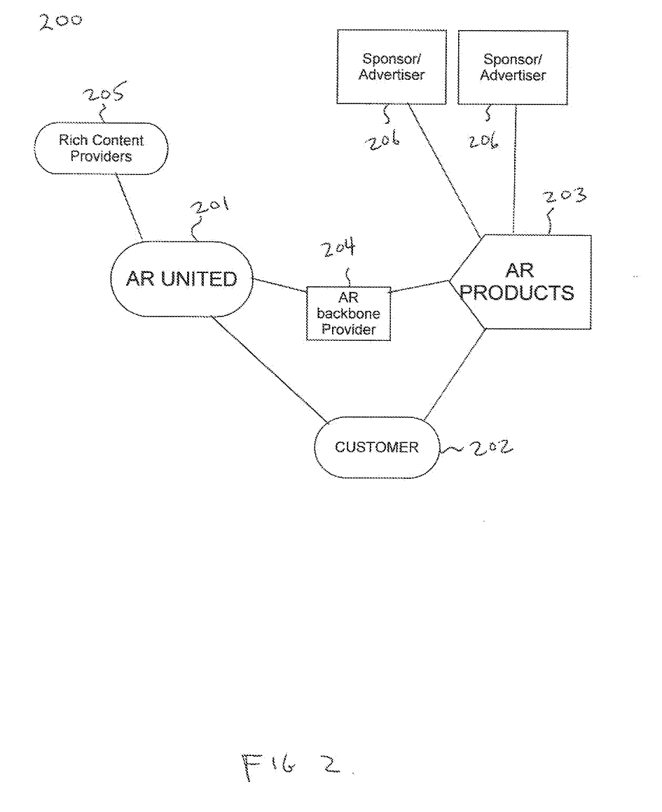

FIG. 2 depicts an exemplary embodiment of an information/marketing/revenue system in accordance with the present invention. The AR UNITED™ system 200 includes one or more facilitators 201, one or more customers 202, one or more AR products purchased or obtained by customers 202, an AR backbone provider or software system 204 and content providers 205. An example of a content provider could be owners of music rights, motion picture rights, Sporting and entertainment rights, celebrity rights or skilled creations made specifically for this process. The AR UNITED™ system also provides for one or more Sponsor/Advertisers 206. A goal of the AR UNITED™ system is to enhance acceptance and use of AR by providing rich and changing content in a financially sustaining ongoing system which necessitates a single or multiple revenue streams to pay for content and administration. The system first creates value by attaching AR to a product creating an AR product 203, an exemplary example of which is seen in FIG. 1. The AR product can now be purchased (creating a revenue stream) for use, further sale, gifting or collected. Additional revenue can now be obtained from Sponsor/Advertisers who can attach their messages to the rich content either before after or during its delivery. In addition, a preferred embodiment of an AR product 203 as seen in FIG. 1 has additional areas suitable for Sponsor/Advertiser logos or other advertisements to be place directly on the product generating an additional revenue stream. An AR product as in FIG. 1 can also use areas on the product to generate separate multiple additional AR messages which could be used for Sponsor/Advertiser revenue. Another source of revenue could be obtained by requiring an App purchase or renewal in order to view the rich content.

A representation example of the AR UNITED™ system are comedy mugs to be used by hotels. AR UNITED wants to provide a mug which when viewed through an AR device shows a comedian doing a comedy routine for entertainment. People do not want to see and hear the same comedy every day so AR UNITED arranges for different comedians performing different routines and provide that on a periodic basis, for example a new routine each day to start your day off right. A hotel, such as Loews, might provide this comedy mug in each of its rooms as an additional hotel amenity. Each day during his stay the hotel guest can be entertained by comedy through that mug. At the end of the guests stay the hotel may sell or give the mug to the customer. One part of the Comedy mug would contain a design or logo which triggers the comedy but another part of the mug could contain Loews' logo or an individual hotel's logo. The hotel guest will see this logo during his stay and also if he takes it after every time he uses the mug or views the latest comedy routine. In addition, he will be showing it to family and friends at home and to his coworkers at work. This will be of tremendous value to loews. The hotel logo on the mug can also be a trigger for AR providing memories of the stay at the hotel and ads or other information about that hotel or others in the chain or specials. It can even be used as an immediate link to book reservations for the hotel. In exchange for customer goodwill, advertising by logo and/or AR and links Loews provides funding to AR UNITED which in turn pays for rich content delivery. Additional revenue is generated by the hotel guest or loews which the hotel guest goes home with the mug after his stay. This comedy mug could also be sold through other outlets providing similar benefits to Loews and similar funding of the rich content.

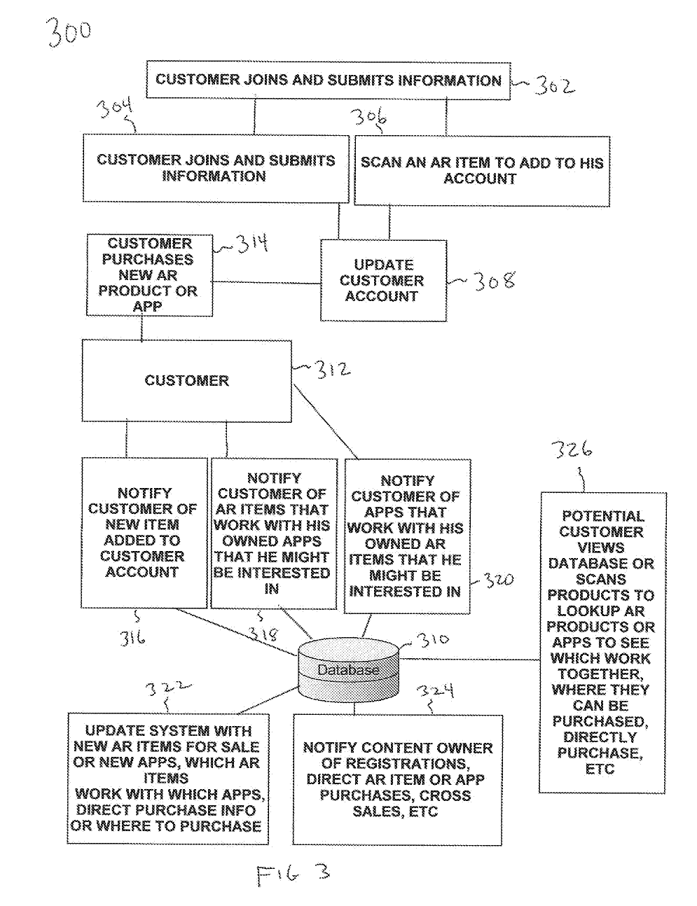

FIG. 3 is a flowchart depicting a series of operations within a system in accordance with an embodiment of the present invention. In the AR UNITED™ system 300, a customer joins and submits their information. In the AR UNITED™ system a customer can get the biggest benefit from the system joining and setting up an account with information 302 but a customer can also access the system as a non-member 326.

When a customer joins he will submit basic account identifying information and he will be asked to submit any AR Products and AR Apps he has 304. This can be accomplished through a variety of means including manually but it can also be accomplished by scanning a barcode or the use of visual recognition scans to identify the item 306.

The customer's account is then updated 308 in the database 310. The system will then give notifications to the customer through email, and/or text or other means. The customer will be notified of the new AR products or Apps that have been added to his account 316.

The system will then analyze the customer's information and make available to the customer a list of some or all of the AR Products available that could also work with the customer's current Apps 318. The customer can purchase any of the AR products through the system or learn where he may purchase the items elsewhere. This cross-selling allows for additional revenue to support the rich content being provided.

The system will also provide a list of other Apps that will work with the customer's AR products 320.

The system will be updated by content providers and others to allow for new AR products which are made available, new AR Apps which are made available, which AR products work with which AR Apps and the reverse, Direct purchase information, where to purchase information, etc. 312.

The system can also notify content owners and others of registrations, Direct purchases of AR products and AR Apps, Cross sales of items, and other information 324

A non-member or potential customer can access the system benefits as well however he will not be able to receive notifications or updates 326

Various advantages of systems in accordance with the present invention are illustrated in the following examples.

A customer purchases a comedy mug as previously described at a retail store. He joins AR UNITED™ and adds the AR Mug and the App to his account. He then receives notification, or can access the system, and learns that the App he has also works with a “Seinfeld” mug. He can then get details on the “Seinfeld” mug, order the mug or learn where to purchase the mug. This provides benefits to the customer, the content provider and others. The customer can also click on the “Seinfeld” mug and learn which Apps are available to him that will work with that mug.

A customer in France purchases a “Seinfeld” mug at a local store and receives a “French” App so that he can hear the content in his native tongue. He joins AR UNITEDcand adds his information. He then receives notification, or can access the system, and learns of other AR products, such as a “Jerry Lewis” mug, that are available that work with his “French” App. He can then learn more about those products or obtain those products.

Similarly, the owner of the “Seinfeld” content would like to have a worldwide audience for any AR product with its content. One solution is to have one design, also known as a trigger for English another design for Spanish and so on. This creates higher costs of production, inventory and storage issues. It is more advantageous for one design to be used and to access the AR UNITED™ website to see and/or obtain an app in the appropriate language for the user.

A potential customer is in a store and is considering purchasing a “Comedy” AR mug. He would like to see what the AR content for that mug would look like. Even more importantly he wants to know that the AR content will function with his device. The potential customer accesses a “Sample” App from AR UNITED™. This allows the customer to see a sample such as one comic doing a routine but denies him full access to the periodic switching of content he would enjoy with the full App. This also allows him to make sure the AR feature will function with his device.

Disney wants to release an AR mug and an AR jewelry box for the live action version of Cinderella. Disney provides information to the AR UNITED system regarding the AR products and the available Apps. AR UNITED™ sends a notification to members that have the “Disney live action” App as well as the “Disney Princesses” App based on the apps. AR UNITED™ also may notify owners of other Disney AR mugs or similar products based on the products.

A customer has a “Laurel and Hardy” AR mug which has operated solely with a Laurel and Hardy App. In the near future there are too few followers to justify the costs of a separate App and that content will be viewable from an App known as “TV Comedy Classics”. Owners of the mug will no longer see the AR functionality of the mug and be in the dark as to why. Through the AR UNITED™ system owners of the mug can be notified, or otherwise learn, of the switch to the new App and download the new App.

1. An information/marketing/revenue method designed to allow the consumer commercialization and widespread consumer acceptance of AR where AR can comprise Augmented Reality, Virtual Reality, Mixed Reality and similar technologies whose steps include
Obtaining rich content changeable on a periodic basis;
Generating one or more streams of revenue to pay for this content and other associated AR costs

2. The method according to claim 1, wherein the AR functionality is attached to a product which can be sold, gifted and/or collected

3. The method according to claim 1, wherein the AR product can also generate revenue through sponsorship/advertising before with or after the content

4. The method according to claim 1, wherein the AR product can generate revenue through additional logos/ads on the product or by using the logo/Ad to trigger additional AR functionality

5. The method according to claim 1, wherein the content could be highly prized music rights, motion picture rights, Sports and entertainment rights, celebrity rights, skilled creations made specifically for this process or other rights

6. The method according to claim 1, wherein the AR product, such as FIG. 1 has been optimized for AR having either or all of one or more flat sides, Sides being sloped to greater match the most common angle of viewing and an instantly identifying feature as part of the product design which identify the product as having AR functionality

7. The method according to claim 1, wherein a customer of an AR product can join and input to a website by manually entering, scanning, using visual recognition or other means, products or apps he possesses or is interested in.

8. The method according to claim 1, wherein customers can be notified or access a list of all Apps that will work with a AR product they have

9. The method according to claim 1, wherein customers can be notified of AR products that will work with the Apps they have

10. The method according to claim 1, wherein recording and scanning are performed over the internet

11. The method according to claim 1, wherein such AR products or Apps can be purchased directly through a website

12. The method according to claim 1, wherein such website can be updated for new AR products and/or new Apps and the analysis regarding compatibility with owned AR product or Apps begins anew.

13. The method according to claim 1, wherein a potential customer can access many but not all features of the system

14. The method according to claim 1, wherein a customer can be notified when the app that powers his AR product will have a change such as payment or switching to a different App.

15. The method according to claim 1, wherein substantial production costs, inventory costs and storage costs are reduced by having the ability to have different apps provide different languages all with the same AR design rather than to resort to different AR trigger designs

16. The method according to claim 1, wherein a potential customer can use a sample app in a store or other environment in order ensure his device will work with the system and to see the specific AR functionality of the AR product and app without having full access to the ongoing rich content
